(19) United States
(12) Patent Application Publication
(10) Pub. No.: US 2025/0190953 A1
(43) Pub. Date: Jun. 12, 2025

(54) METHOD FOR VEHICLE MAINTENANCE AND A DEVICE USING SAME

(71) Applicants: HYUNDAI MOTOR COMPANY, Seoul (KR); KIA CORPORATION, Seoul (KR)

(72) Inventors: Hong Seok Yang, Hwaseong-si (KR); Jung Seok Suh, Yongin-si (KR); Young Chun Cho, Incheon (KR)

(73) Assignees: HYUNDAI MOTOR COMPANY, Seoul (KR); KIA CORPORATION, Seoul (KR)

(21) Appl. No.: 18/819,798

(22) Filed: Aug. 29, 2024

(30) Foreign Application Priority Data
Dec. 7, 2023 (KR) 10-2023-0176447

(51) Int. Cl. G06Q 10/20; G06Q 50/47

(52) U.S. Cl. CPC G06Q 10/20; G06Q 50/47

(57) ABSTRACT

A method and a device for vehicle maintenance are provided. The method includes receiving, from a user terminal, a hailing service request including a pick-up position and a drop-off position. The method also includes identifying one or more candidate vehicles to request a user of the user terminal to perform a maintenance task based on one or both of the pick-up position, the drop-off position. The method also includes transmitting, to the user terminal, information on each candidate vehicle and information on the maintenance task required for each candidate vehicle. The method further includes receiving, from the user terminal, a list of one or more target vehicles selected from among the candidate vehicles. The method additionally includes transmitting, to the target vehicles, a notification message for informing that the maintenance task is scheduled to be performed.

### CROSS-REFERENCE TO RELATED APPLICATION

The present application claims priority to Korean Patent Application No. 10-2023-0176447, filed on Dec. 7, 2023, the entire contents of which are incorporated herein by reference.

### TECHNICAL FIELD

The present disclosure relates to a method for vehicle maintenance and a device using same.

### BACKGROUND

The content described in this section merely provides background information related to the present disclosure and does not constitute related art.

A hailing service is a service for connecting a consumer who wants to ride to a vehicle that provides a riding service in real time. With the development of an autonomous driving technology, a scheme for providing a hailing service using an autonomous vehicle has been attempted.

Appropriate maintenance is necessary for stable operation of an autonomous vehicle. However, because the autonomous vehicle does not necessarily have a full-time driver, it is difficult to take immediate measures even when a problem that can be easily solved occurs. Accordingly, a separate engineer must be called to a vehicle to solve the problem, which unnecessarily wastes manpower and time.

### SUMMARY

According to an aspect of the present disclosure, a computer-implemented method for vehicle maintenance is provided. The computer-implemented method includes receiving, from a user terminal, a hailing service request including a pick-up position and a drop-off position. The computer-implemented method also includes identifying one or more candidate vehicles to request a user of the user terminal to perform a maintenance task based on one or both of the pick-up position or the drop-off position. The computer-implemented method further includes transmitting, to the user terminal, information on each candidate vehicle and information on the maintenance task required for each candidate vehicle. The computer-implemented method further still includes receiving, from the user terminal, a list of one or more target vehicles selected from among the candidate vehicles. The computer-implemented method additionally includes transmitting, to the target vehicles, a notification message for informing that the maintenance task is scheduled to be performed.

According to another aspect of the present disclosure, a device is provided. The device includes a memory configured to store instructions and at least one processor. The at least one processor is configured to execute the instructions to receive, from a user terminal, a hailing service request including a pick-up position and a drop-off position. The at least one processor is also configured to execute the instructions to identify one or more candidate vehicles to request a user of the user terminal to perform a maintenance task based on one or both of the pick-up position or the drop-off position. The at least one processor is further configured to execute the instructions to transmit, to the user terminal, information on each candidate vehicle and information on the maintenance task required for each candidate vehicle. The at least one processor is further still configured to execute the instructions to receive, from the user terminal, a list of one or more target vehicles selected from among the candidate vehicles. The at least one processor is additionally configured to execute the instructions to transmit, to the target vehicles, a notification message for informing that the maintenance task is scheduled to be performed.

### BRIEF DESCRIPTION OF THE DRAWINGS

FIG. 1 is a block diagram schematically illustrating a system for a hailing service, according to an embodiment of the present disclosure.

FIG. 2 is a block diagram schematically illustrating a hailing device, according to an embodiment of the present disclosure.

FIGS. 3A and 3B are illustrative diagrams illustrating various examples of a condition for identifying a candidate vehicle, according to embodiments of the present disclosure.

FIG. 4 is a flowchart illustrating a method of providing a hailing service, according to an embodiment of the present disclosure.

FIGS. 5A-5C are diagrams illustrating example screens that can be displayed on a user terminal, according to embodiments of the present disclosure.

FIG. 6 is a flowchart illustrating an operation of the hailing device, according to an embodiment of the present disclosure.

FIG. 7 is a block diagram schematically illustrating an example computing device that can be used to implement the method or device according to embodiments of the present disclosure.

### DETAILED DESCRIPTION

The present disclosure provides a method and a device capable of inducing a user of a hailing service to perform a maintenance task on a pick-up vehicle and/or another vehicle located on a walking route or driving route.

The features of the present disclosure are not limited to the features mentioned above. Other features not mentioned should be clearly understood by those having ordinary skill in the art from the description below.

Hereinafter, embodiments of the present disclosure are described in detail with reference to the accompanying drawings. In the following description, like reference numerals designate like elements even when the elements are illustrated in different drawings. Further, in the following description of some embodiments, a detailed description of known functions and configurations incorporated therein has been omitted for the purpose of clarity and for brevity.

Additionally, various terms such as first, second, A, B, (a), (b), etc., are used solely to differentiate one component from the other. Such terms do not to imply or suggest the substances, order, or sequence of the components. Throughout this specification, the terms “including,” “comprising”, or the like are intended to specify the presence of the mentioned components. Such terms do not exclude presence or addition of other components unless specifically stated to the contrary. The terms such as “unit,” “module,” “device,” “controller,” or the like refer to one or more units for processing at least one function or operation, and may be implemented by hardware, software, or a combination thereof. The operations of the functions described in connection with the forms disclosed herein may be embodied directly in a hardware or a software module executed by a processor, or in a combination thereof.

When a component, device, element, or the like of the present disclosure is described as having a purpose or performing an operation, function, or the like, the component, device, or element should be considered herein as being “configured to” meet that purpose or perform that operation or function.

The following detailed description, together with the accompanying drawings, is intended to describe embodiments of the present disclosure. The description is not intended to represent the only embodiments in which the present disclosure may be practiced.

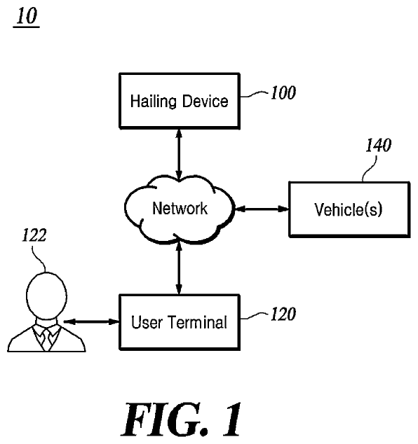

FIG. 1 is a block diagram schematically illustrating a system for a hailing service, according to an embodiment of the present disclosure.

As illustrated in FIG. 1, a system 10 for a hailing service according to an embodiment of the present disclosure may include all or some of a hailing device 100, a user terminal 120, and one or more vehicles 140.

The hailing device 100 may be a device that provides a hailing service to users. For example, the hailing device 100 may be a server that is operated by a company that provides the hailing service. When the hailing device 100 receives a call request from the user terminal 120, the hailing device 100 may dispatch any one of the vehicles 140 to pick up the user 122 and/or request a user 122 to perform a maintenance task for a specific vehicle 140. The maintenance task may include various tasks for maintaining functions and safety of the vehicles 140. For example, the maintenance task may have a concept including a task for a vehicle 140 itself and/or a task for improving an external environment of the vehicle 140.

The hailing device 100 may be connected to the user terminal 120 and/or the vehicles 140 through a wireless network to exchange data with each other. The hailing device 100 may store and manage information collected from the user terminal 120 and/or the vehicles 140.

The user terminal 120 may be a device possessed by the user 122 who wishes to call a vehicle. For example, the user terminal 120 may be provided as one of various components of an electronic device, such as a smart phone, a smart watch, a tablet, a computer, an ultra-mobile PC (UMPC), a workstation, a net-book, a personal digital assistant (PDA) assistant, a portable computer, or a portable multimedia player (PMP). However, the user terminal 120 is not limited to types of devices described above. A device may serve as the user terminal 120 regardless of a specific type as long as the device may participate in a service provided by the hailing device 100 through a network.

The user terminal 120 according to an embodiment of the present disclosure may have an application for a hailing service installed therein. The user terminal 120 may receive a request for a maintenance task for one or more vehicles from the hailing device 100 through the application for the hailing service.

The vehicles 140 includes any travel means for picking up the user 122 at a pick-up position and moving the user 122 to a drop-off position. For example, the vehicles 140 may include a taxi and/or a shared vehicle. Further, the vehicles 140 may include an autonomous vehicle and/or a remotely operated vehicle. However, the present disclosure is not limited to the examples described above.

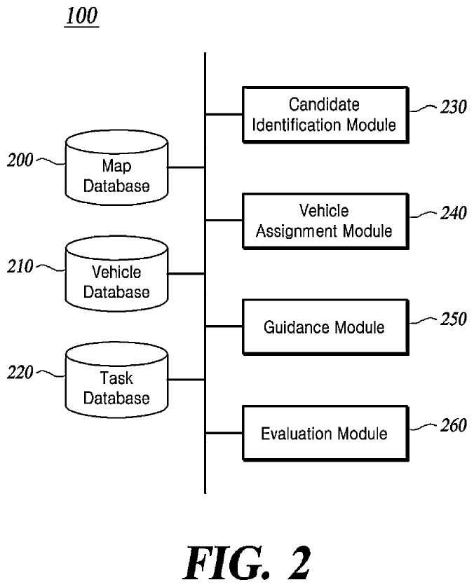

FIG. 2 is a block diagram schematically illustrating a hailing device, according to an embodiment of the present disclosure.

As illustrated in FIG. 2, the hailing device 100 according to an embodiment of the present disclosure may include all or some of a map database 200, a vehicle database 210, a task database 220, a candidate identification module 230, a vehicle assignment module 240, a guidance module 250, and an evaluation module 260. The blocks illustrated in FIG. 2 are not necessarily essential components. Some blocks may be changed or deleted and/or other blocks may be added, in some embodiments. The components illustrated in FIG. 2 represent functionally distinguished components. The components illustrated in FIG. 2 may be implemented in a form in which at least one component is integrated with another component in a physical environment.

The map database 200 may store map information and road information for identifying a position of the user 122 and/or the vehicles 140 and calculate a walking route and/or driving route.

The vehicle database 210 may store information on the vehicles 140 that is managed by a hailing service provider. For example, information stored in the vehicle database 210 may include an identifier, current position, and status type of the vehicle, required maintenance task, and/or a progress status of the maintenance task. The status type of the vehicle may be classified into a plurality of types according to a predetermined criterion. Table 1 shows an example of the status types of the vehicle, according to an embodiment.

TABLE 1

| Status | | | |
|---|---|---|---|
| type | Category | Description | Status example |
| 0 | Normal | A vehicle that is capable of | |
| | | autonomous driving and has no | |
| | | problems upon movement | |
| 1 | Maintenance | A vehicle that is capable of | A car door is not closed |
| | required | autonomous driving and | automatically |
| | Level 1 | moving, but requires checking | The Car door is not closed |
| | | due to signs of breakdown or | completely |
| | | abnormality, or requires simple | Difficulty in operation of some |
| | | measures for normal operation | functions due to foreign matter |
| | | | on sensors (for example, a |
| | | | camera or lidar) |
| | | | Shortage of a washer fluid to |
| | | | clean the sensors |
| | | | Hood/trunk is open |
| | | | Hood/trunk not closed |
| | | | Abnormality of tire pressure |
| 2 | Maintenance | A vehicle is unavailable (or | Movement is not feasible due |
| | required | not feasible) to move and/or | to presence of obstacles (for |
| | Level 2 | a customer cannot board | example, a box or a cone) around |
| | | immediately because of the | the vehicle |
| | | need for inspection on key | There is foreign matter on |
| | | functions of autonomous | sensors which are essential upon |
| | | driving | movement |
| 3 | Failure | Autonomous driving is | Sensor failure |
| | | impossible and repair by an | Vehicle damage |
| | | engineer is required | |

Referring to Table 1, the status of the vehicle may be divided into four types. Among these, a first type indicates a state in which traveling is possible even though a maintenance task is required but is not completed. Further, a second type indicates a state in which traveling is not feasible until the maintenance task is completed. The first type can be distinguished from a zero-th type in that the maintenance task must be performed before the user 122 boards. The second type can be distinguished from a third type, that indicates a state in which repair by an engineer is required, in that the status can be switched to the state in which traveling is possible through simple measures that do not require specialized knowledge.

Types 1 and 2 can be classified based on the maintenance task required. Table 2 shows the maintenance task corresponding to each status type, according to an embodiment.

TABLE 2

| Status | | |
|---|---|---|
| type | Category | Maintenance task example |
| 1 | Maintenance | Visually checking whether or not |
| | required | there is abnormality in a vehicle |
| | Level 1 | Refilling a sensor cleaning fluid |
| | | of the vehicle |
| | | Closing a hood or door of the vehicle |
| | | Replacing or Cleaning a component |
| | | predefined as non-essential for |
| | | autonomous driving of the vehicle |
| 2 | Maintenance | Removing obstacles present near |
| | | the vehicle |
| | required | Replacing or Cleaning a component |
| | Level 2 | predefined as essential for |
| | | autonomous driving of a vehicle |

Referring to Table 2, even when the maintenance task requires the user 122 to do the same or similar actions (e.g. replacing or cleaning), the status type of vehicle may vary depending on whether a maintenance task application target is an essential component for autonomous driving. To this end, for each component in the vehicle, it may be predefined whether the component is essential for autonomous driving. For example, sensors for monitoring the surroundings of a vehicle (for example, a front camera, a radar, or a lidar) may be predefined as essential components for autonomous driving. As another example, sensors for monitoring the inside of the vehicle (for example, internal cameras or biometric sensors) may be predefined as those that are not essential for autonomous driving. In some implementation examples, even in the case of the same component, the status type of the vehicle may vary depending on a current status of the component. For example, when a pollution level of the sensor is low, the status type may be classified into the first type. On the other hand, when the pollution level of the sensor is high, the status type may be classified into the second type.

The task database 220 may store information on the maintenance task that can be requested to the user 122. For example, the task database 220 may store, for each maintenance task, an expected time required for the maintenance task, a level of difficulty, and/or a guidance to be provided to the user 122. The expected time required may be designated in advance by a service provider, or may be calculated based on statistical analysis of a history of the maintenance task previously performed by users of the hailing service. The guidance may be provided as a combination of one or more of text, a still image, and/or a moving image (e.g. video). The level of difficulty of maintenance task may be classified according to the expected time required, the complexity of an action or a measure that the user 122 must take, and/or a guidance providing scheme. Table 3 shows the maintenance task corresponding to each level of difficulty, according to an embodiment.

TABLE 3

| Level of | | |
|---|---|---|
| difficulty | Description | Maintenance task example |
| Level 1 | Only a status of a vehicle is | A damage status of the outside of the |
| | checked without any measures | vehicle is checked, and photographs |
| | (when vehicle status needs to be | are taken and uploaded |
| | shared, a user takes photographs | An appearance of tires is checked |
| | and uploads the photographs) | due to an abnormality of tire pressure. |
| Level 2 | Simple measures of 3 or less, | A fuse of the vehicle is replaced due |
| | with required time of less than 5 | to blowing of the fuse |
| | minutes | obstacles around a trunk are |
| | When a method for measures | removed and then, it is checked |
| | can be expressed in a photograph | whether or not a trunk is closed |
| | or simple text | normally. |
| Level 3 | Complex measures including | Initialization after entrance to |
| | five or more operations or | factory mode is performed due to |
| | required time more than 5 minutes | navigation software conflict |
| | When a method for measures | Tire pressure is adjusted by using |
| | can be prepared through a video | TMK due to an abnormality of tire |
| | or real-time communication with | pressure |
| | an engineer | |

In some implementation examples, the task database 220 may further include user conditions recommended for performing the maintenance task. For example, the task database 220 may further store, for each maintenance task, an age condition or height condition of a target user to which the maintenance task is requested. As an example, in the case of a task for cleaning a sensor located in an upper portion of the vehicle, a predetermined height condition may be set according to the height of the vehicle. As another example, different age conditions may be set for each level of difficulty.

The candidate identification module 230 may identify a set of one or more candidate vehicles based on the hailing service request received from the user terminal 120 and information stored in the map database 200 and the vehicle database 210. The candidate vehicle may be a vehicle for which a maintenance task is requested to the user 122. The candidate vehicle may be a vehicle whose status type is the first type or the second type. The candidate identification module 230 may identify a first type vehicle and/or a second type vehicle satisfying a predetermined condition as a candidate vehicle among vehicles for which information is stored in the vehicle database 210.

The candidate vehicle may include a pick-up candidate vehicle that can move to the position of the user 122 (or the pick-up position desired by the user 122) for the maintenance task and/or a non-pick-up candidate vehicle that requires the user 122 to move to a position thereof on foot or by using another vehicle. In this case, a status type of the pick-up candidate vehicle may be the first type. The status type of the non-pick-up candidate vehicle may be any of the first type or the second type.

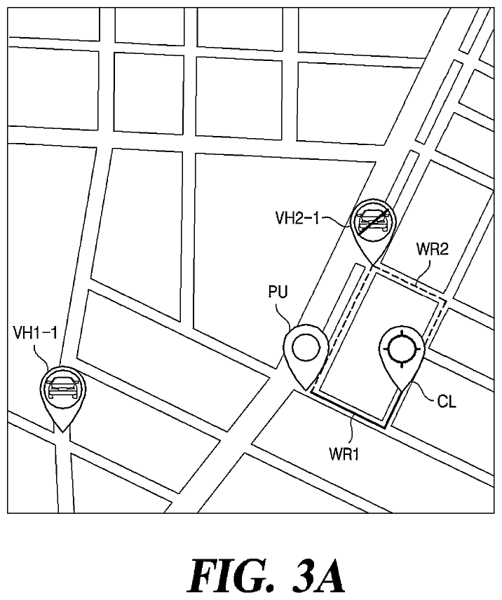

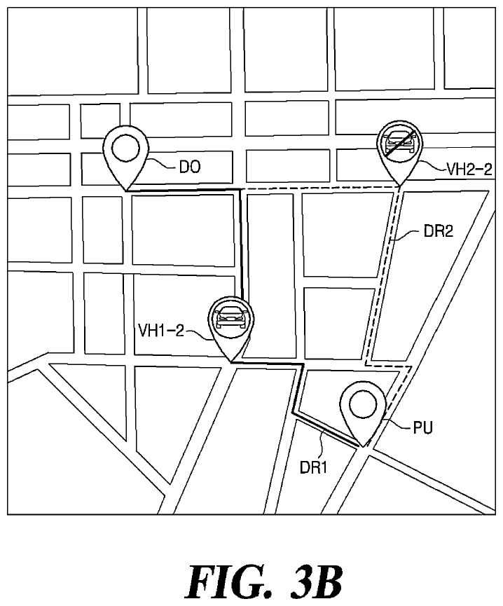

FIGS. 3A and 3B are illustrative diagrams illustrating various examples of a condition for identifying a candidate vehicle, according to embodiments of the present disclosure.

Referring to FIG. 3A, the candidate identification module 230 may identify candidate vehicles VH1-1 to VH2-1 based on the user's current position and/or the pick-up position PU at which the user 122 wishes to board.

The candidate identification module 230 may identify the first type of vehicle VH1-1 that satisfies a first condition associated with the pick-up position PU as the pick-up candidate vehicle. The first condition may be satisfied when the first type of vehicle VH1-1 can move to the pick-up position PU and pick up the user 122 before a predetermined reference time. In some embodiments, the reference time may be determined based on a desired departure time designated by the user 122. For example, the candidate identification module 230 may identify the first type of vehicle VH1-1 that can arrive at the pick-up position PU before the desired departure time as the pick-up candidate vehicle.

Additionally, or alternatively, the reference time may be determined based on an expected time required for the maintenance task required for the first type of vehicle VH1-1. For example, the reference time may be time obtained by subtracting the expected time required for the maintenance task required for the first type of vehicle VH1-1 from the desired departure time designated by the user 122. Accordingly, the candidate identification module 230 may identify the first type of vehicle VH1-1 for which the maintenance task can be completed before the desired departure time, as the pick-up candidate vehicle.

Additionally, or alternatively, the reference time may be determined based on a time expected to take to move from the user's current position CL to the pick-up position PU. For example, the reference time may be determined by adding the current time and the expected time required. Accordingly, the candidate identification module 230 may identify the first type of vehicle VH1-1 that can arrive at the pick-up position PU at a point in time (for example, within 2 minutes) close to the time when the user 122 is expected to arrive at the pick-up position PU as a pick-up candidate vehicle. In an example, when there is one or more non-pick-up candidate vehicles VH2-1 that satisfy the second condition to be described below, an expected required time may further include a time to pass through the vehicle VH2-1 and/or an expected time required for the maintenance task required for the vehicle VH2-1. For example, the candidate identification module 230 may identify the first type of vehicle VH1-1 that can arrive at the pick-up position PU as the pick-up candidate vehicle at a point in time close to a point in time when the user 122 is expected to arrive at the pick-up position PU after performing the maintenance task of the non-pick-up candidate vehicle VH2-1 that satisfies the second condition.

The candidate identification module 230 may identify the second type of vehicle VH2-1 that satisfies the second condition associated with the user's current position CL and the pick-up position PU as the non-pick-up candidate vehicle. The second condition may be satisfied when a length of a walking route WR2 connecting the user's current position CL, the position of the second type of vehicle VH2-1, and the pick-up position PU is equal to or smaller than a predetermined threshold length. The threshold length may be obtained by adding a preset additional allowable distance to a length of an optimal walking route WR1 between the user's current position CL and the pick-up position PU. The optimal walking route WR1 may be, for example, a route with the shortest distance or shortest time. The additional allowable distance may be designated by the hailing service provider or the user 122. Alternatively, the additional allowable distance may be determined based on an average walking speed calculated based on the height of the user 122.

The candidate identification module 230 may convert the additional allowable distance into an additional allowable time based on an average walking speed. For example, the candidate identification module 230 may identify a second type of vehicle (not illustrated) located on the optimal walking route WR1, and/or a vehicle VH2-1 located on a detour walking route WR2 that takes an additional time of a predetermined threshold time (for example, 5 minutes) or less as compared to the optimal walking route WR1, as the non-pick-up candidate vehicle.

The candidate identification module 230 may calculate a walking route passing through the second type vehicles located around the user's current position CL and/or pick-up position PU for each of the second type vehicles. The candidate identification module 230 may compare a length of the route (or walking time) with a threshold length (or threshold time) to determine whether or not the second condition is satisfied.

Additionally, or alternatively, the second condition may further include an additional condition for the desired departure time designated by the user 122. The additional condition can be satisfied when the user 122 is expected to be able to complete the maintenance task required for the second type of vehicle VH2-1 and arrive at the pick-up position PU before the desired departure time. The candidate identification module 230 may determine whether or not the additional condition is satisfied based on the walking route WR2 passing through the second type of vehicle VH2-1, the expected time required for the maintenance task required for the second type of vehicle VH2-1, and the desired departure time designated by the user 122.

The candidate identification module 230 may identify the candidate vehicle by applying different conditions depending on whether or not the user 122 has designated the desired departure time and/or a distance between the user's current position CL and the pick-up position PU. For example, the candidate identification module 230 may identify the second type of vehicle VH2-1 located on the walking route as the non-pick-up candidate vehicle when the distance between the user's current position CL and the pick-up position PU is equal to or greater than a threshold distance determined in advance.

Referring to FIG. 3B, the candidate identification module 230 may identify one or more non-pick-up candidate vehicles VH1-2 to VH2-2 present on the route between the pick-up position PU at which the user 122 wants to board and the drop-off position DO at which the user 122 wants to get off.

The candidate identification module 230 may identify the vehicles VH1-2 to VH2-2 satisfying a third condition associated with the pick-up position PU and the drop-off position (DO) as non-pick-up candidate vehicles.

The third condition may be satisfied when a length of driving routes DR1 to DR2 connecting the pick-up position PU, the position of the first or second type of vehicle VH1-2 or VH2-2, and the drop-off position DO is equal to or smaller than a threshold length determined in advance. The threshold length may be a value obtained by adding a preset additional allowable distance to a length of the optimal driving route DR1 between the pick-up position PU and the drop-off position DO. The optimal driving route DR1 may be the route with the shortest distance or shortest time. However, the present disclosure is not limited thereto. The additional allowable distance may be designated by the hailing service provider or the user 122. Alternatively, the additional allowable distance may be determined based on an average movement speed of the vehicle in each section of the route.

The candidate identification module 230 may convert the additional allowable distance into the additional allowable time based on an average movement speed for each section. For example, the candidate identification module 230 may identify a vehicle VH1-2 located on the optimal driving route DR1 and/or a vehicle VH2-2 located on a detour driving route DR2 requiring a predetermined threshold time (for example, 20 minutes) or less as compared to the optimal driving route DR1 as the non-pick-up candidate vehicle. FIG. 3B illustrates an example in which the non-pick-up candidate vehicle VH1-2 located on the optimal driving route DR1 is the first type of vehicle, and another non-pick-up candidate vehicle VH2-2 located on the detour driving route DR2 is the second type of vehicle. However, the present disclosure is not limited thereto. The candidate identification module 230 may identify a vehicle of any one of the first type and the second type located on any route, that satisfies a predetermined condition, as the non-pick-up candidate vehicle.

The candidate identification module 230 may calculate a driving route passing through the position of the vehicle for each of the first and second type of vehicles that can form a route between the pick-up position PU and the drop-off position DO. The candidate identification module 230 may compare the calculated length of the driving route (or driving time) with a predetermined threshold length (or threshold time) to determine whether or not the third condition is satisfied.

The candidate identification module 230 may additionally consider personal information of the user 122 when identifying a candidate vehicle. The personal information of the user 122 may include a height and/or age of the user 122. For example, the candidate identification module 230 may acquire a recommendation condition for the maintenance task required for the candidate vehicle from the task database 220. The candidate identification module 230 may then exclude a vehicle from a set of candidate vehicles when the height and/or age of the user 122 does not meet the recommendation conditions.

The vehicle assignment module 240 may determine a pick-up vehicle to pick up the user 122 and/or a target vehicle on which the user 122 performs the maintenance task. To this end, the vehicle assignment module 240 may generate a maintenance request list for the identified candidate vehicles and transmit the maintenance request list to the user terminal 120.

The maintenance request list may include information on each candidate vehicle and the information on the maintenance task required for each candidate vehicle. Table 4 shows the maintenance request list for the candidate vehicles illustrated in FIGS. 3A and 3B, according to an embodiment. In Table 4, information unnecessary for description has been omitted, as indicated by “-”.

TABLE 4

| | VH1-1 | VH2-1 | VH1-2 | VH2-2 |
|---|---|---|---|---|
| Identifier | — | — | — | — |
| Status type | 1 | 2 | 1 | 2 |
| Approach | Vehicle moves | Pass while | Pass while | Pass while |
| method | to pick-up | walking | driving | driving |
| | position | | | |
| Current | — | — | — | — |
| position | | | | |
| Waiting time | 2 minutes | (none) | (none) | (none) |
| Walking route | WR1 | WR2 | — | — |
| Driving route | — | — | DR1 | DR2 |
| Detour | (none) | +50 m/+1 | (none) | +3 minutes |
| distance/time | | minute | | |
| Expected | Refill a | Check | Check tire | Clean sensors |
| maintenance | washer fluid | surrounding | appearance | against |
| task | | obstacles | | contamination |
| Level of task | 2 | 1 | 1 | 3 |
| difficulty | | | | |
| Expected task | Less than 5 | Less than 3 | 1 minute | 10 minutes |
| time | minutes | minutes | | |
| Expected | 2000 won | 1000 won | 800 won | 3000 won |
| credit | | | | |

Referring to Table 4, information on the candidate vehicles may include the identifier of the candidate vehicle, the status type of the candidate vehicle (first type or second type), a method of meeting the candidate vehicle, and/or the current position of the vehicle. The information on the pick-up candidate vehicle (e.g. VH1-1) satisfying the first condition described above may further include a time for which the user 122 must wait for the candidate vehicle to arrive at the pick-up position PU. As another example, information on the non-pick-up candidate vehicle (e.g. VH2-1) satisfying the second condition described above may include an additional required time as compared to the walking route WR2 passing the candidate vehicle and/or an optimal walking route WR1 of the walking route WR2. Information on the non-pick-up candidate vehicle (e.g. VH1-2 and VH2-2) satisfying the third condition described above may further include an additional required time as compared to the driving routes DR1 to DR2 passing the candidate vehicle and/or an optimal driving route DR1 of the driving routes DR1 to DR2.

The information on the maintenance task may include content of the maintenance task, the expected time required for the maintenance task, the level of difficulty of the maintenance task, and/or expected reward credit expected to be able to be obtained by the user 122 upon completion of the maintenance task. The vehicle assignment module 240 can inquire about the information on the maintenance task required for each candidate vehicle from the vehicle database 210 and the task database 220. The vehicle assignment module 240 may calculate expected reward credit based on the information on the candidate vehicles and information on the maintenance task required for the candidate vehicle. The expected reward credit may be calculated based on a time expected to be required by the user 122 or the pick-up vehicle passing through the candidate vehicle, a time expected to be required for the maintenance task required for the candidate vehicle, and/or the level of difficulty of the maintenance task of the maintenance task, for each candidate vehicle. For example, the vehicle assignment module 240 may calculate the expected reward credit based on Equation 1.

$$credit = ( {w}_{1} \cdot Δ {t}_{w a l k} + {w}_{2} \cdot Δ {t}_{d r i v e} + {w}_{3} \cdot {t}_{task} ) \times {D}_{task} \qquad [ Equation 1 ]$$

In Equation 1, Δt_{walk} indicates an additional walking time expected to be additionally spent by passing through the candidate vehicle, Δt_{drive} indicates an additional driving time expected to be additionally spent by passing through the candidate vehicle, and tₜₐₛₖ indicates the expected time required for the maintenance task. Further, w₁-w₃ indicate weight coefficients assigned to each time factor and may be determined in advance by the hailing service provider, and Dₜₐₛₖ indicates a score corresponding to the level of difficulty of the maintenance task, and can also be determined in advance by the hailing service provider.

In some embodiments, the vehicle assignment module 240 may assign priority to each candidate vehicle in the maintenance request list. The vehicle assignment module 240 can assist the user 122 in selection by assigning high priority to a vehicle for which measures are easy. As an example, vehicle for which measures are easy may be a vehicle that requires a maintenance task with a low level of difficulty. As another example, the vehicle for which measures are easy may be a vehicle that does not require a detour route (for example, a vehicle satisfying the first condition, or a vehicle located on an optimal route). As another example, the vehicle for which measures are easy may be a vehicle that does not require drop-off at the pick-up vehicle (for example, a vehicle satisfying the first condition or the second condition).

In some embodiments, the vehicle assignment module 240 may recommend a combination of one or more candidate vehicles to the user 122 based on information input from the user 122. For example, when the user 122 designates a desired arrival time for the drop-off position, the vehicle assignment module 240 may calculate a combination of candidate vehicles expected to be able to complete the maintenance task and move to the drop-off position before the desired arrival time, and recommend the combination to the user 122.

The vehicle assignment module 240 may receive a maintenance acceptance list for one or more target vehicles from the user terminal 120 as a response to the maintenance request list. Here, the target vehicle may be a vehicle selected by the user 122 from among candidate vehicles. For example, the maintenance acceptance list may include an identifier of the target vehicle.

The vehicle assignment module 240 may determine a pick-up vehicle to move the user 122 from the pick-up position to the drop-off position based on the maintenance acceptance list.

For example, when a pick-up candidate vehicle satisfying the first condition described above is selected as the target vehicle, the vehicle assignment module 240 may determine the pick-up candidate vehicle as the pick-up vehicle. As another example, when there is no pick-up candidate vehicle among the target vehicles selected by the user 122, the vehicle assignment module 240 may determine any one of a zero-th type of vehicles (that is, normal vehicles) according to a known dispatch algorithm as the pick-up vehicle.

The vehicle assignment module 240 may decide the walking route of the user 122 and/or the driving route of the pick-up vehicle based on the positions of one or more selected target vehicles. The vehicle assignment module 240 may provide the decided driving route to the pick-up vehicle. The vehicle assignment module 240 may instruct the pick-up vehicle to move to the pick-up position, pick up the user 122 and then, move to the drop-off position via positions of the one or more target vehicles.

The vehicle assignment module 240 may transmit a maintenance schedule notification for informing that a maintenance task is scheduled to be performed by the user 122 to the one or more selected target vehicles. The vehicle assignment module 240 may instruct the target vehicle to assign a temporary access right of the user 122 through the maintenance schedule notification. For example, when the maintenance task required for the target vehicle is to clean cameras inside the target vehicle, the vehicle assignment module 240 may use the user terminal 120 to transmit a token for unlocking doors of the target vehicle and verification information for this to the user terminal 120 and/or the target vehicle.

The guidance module 250 may provide a decided walking route and/or driving route to the user terminal 120. The guidance module 250 may calculate time on which the user 122 is expected to arrive at the drop-off position, based on a decided walking route, a decided driving route, and/or the expected time required for the maintenance task required for each target candidate vehicle, and provide the calculated scheduled arrival time to the user terminal 120.

The guidance module 250 may provide a guidance for the maintenance task to the user terminal 120. When a plurality of target vehicles is selected, the guidance module 250 may sequentially provide the guidance based on an approach order of each target vehicle. The guidance module 250 may provide the guidance in advance before the user 122 or the pick-up vehicle arrives at a specific target vehicle, thereby leading the user 122 to ascertain measures required for the maintenance task in advance.

When the level of difficulty of the maintenance task is above a certain level or a request is received from the user 122, the guidance module 250 may assign a counselor to provide the guidance to the user 122 through a real-time video call and/or voice call. The guidance module 250 may calculate the scheduled start time of each maintenance task based on a position of each target vehicle, the expected time required for the maintenance task required for each target vehicle, and the current position of the user 122 or the pick-up vehicle, and reserve a counselor in advance according to the calculated start time.

The evaluation module 260 may evaluate whether or not the maintenance task has been completed and provide reward credit to the user 122 according to an evaluation result.

The evaluation module 260 may collect whether or not the maintenance task has been completed or data from which whether or not the maintenance task has been completed can be confirmed, from the target vehicle or the user terminal 120.

As an example, the evaluation module 260 may receive a message indicating whether or not the maintenance task has been completed from each target vehicle. To this end, each target vehicle may independently determine whether or not the maintenance task has been completed by utilizing various sensors mounted on the target vehicle itself. For example, when the maintenance task required for the specific target vehicle is to close a trunk door, the target vehicle may determine whether or not the trunk door is normally closed using a sensor mounted on the trunk door.

As another example, the evaluation module 260 may collect images obtained by capturing the inside or outside of the target vehicle from the target vehicle or the user terminal 120 to determine whether or not the maintenance task has been completed. For example, when a maintenance task required for a specific target vehicle is to remove an obstacle in front of the vehicle, the evaluation module 260 may collect videos obtained by capturing a forward side of the target vehicle from the target vehicle or the user terminal 120, and detect the presence or absence of an obstacle in the collected video to determine whether or not the obstacle is removed. The image may be a still image or a moving image (e.g. video), for example.

As still another example, the evaluation module 260 may receive feedback from a third party regarding whether the maintenance task have been completed. For example, when a guide provides a guidance for a maintenance task to the user 122 through a real-time video call, the evaluation module 260 may receive whether or not the maintenance task has been completed, from the guide.

The evaluation module 260 may calculate the reward credit to be finally assigned to the user 122 based on whether or not the maintenance task for each target vehicle has been completed. As an example, the evaluation module 260 may calculate the reward credit based on Equation 1 described above for each target vehicle for which maintenance task has been completed, and decide final reward credit by adding up the calculated reward credits. In this case, an additional traveling time (e.g. additional walking time and/or additional driving time) and the time required for the maintenance task may be an additional time actually spent on movement and a time actually spent on the maintenance task. As another example, a maximum amount of decided reward credits may be limited based on a difference between an expected time informed to the user 122 and an actual required time. This makes it possible to cope with a situation in which the user 122 intentionally increases a traveling time and/or task time in order to receive more reward credits.

The evaluation module 260 may inform the user terminal 120 of the decided final reward credit or a difference between an expected reward credit and the decided final reward credit. The reward credit may be provided in a manner of, for example, a discount on a usage fee for a current hailing service or accumulation of points that can be used when a service is used in the future. However, the present disclosure is not limited thereto.

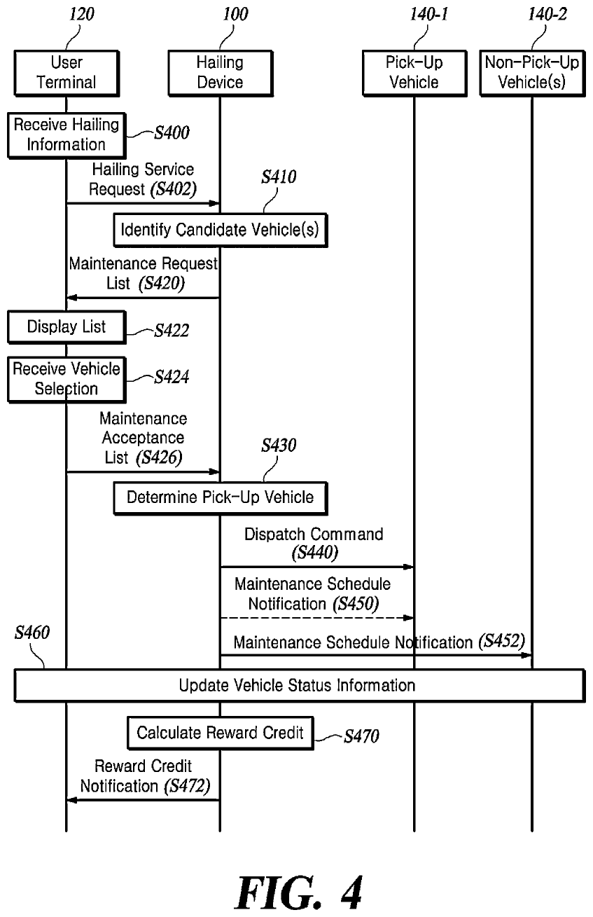

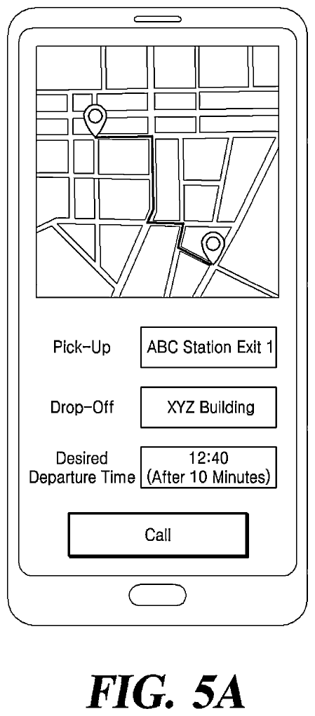

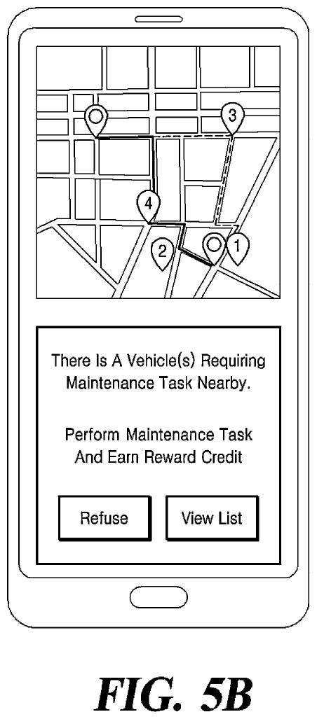

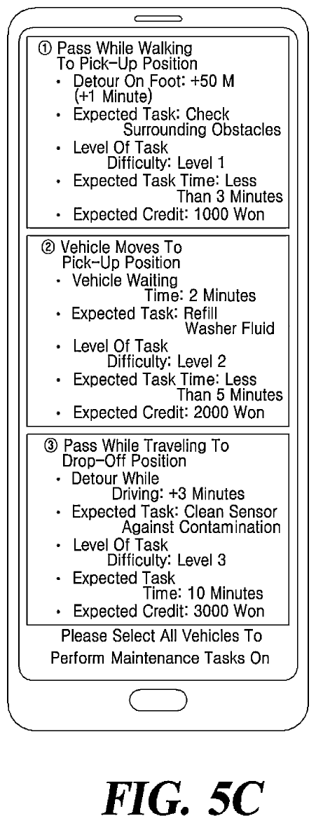

FIG. 4 is a flowchart illustrating a method of providing a hailing service, according to an embodiment of the present disclosure. FIGS. 5A-5C are diagrams illustrating example screens that can be displayed on the user terminal, according to embodiments of the present disclosure.

In an operation S400, the user terminal 120 may receive information required for a hailing request from the user 122. Referring to FIG. 5A, the information required for a hailing request may include the pick-up position and the drop-off position. The user terminal 120 may overlay and display a graphic object (e.g. pin object) corresponding to the pick-up position and a graphic object corresponding to the drop-off position on the map. The user 122 can adjust the pick-up position and the drop-off position by moving the graphic objects to specific points. Additionally, the information required for a hailing request may include the desired departure time.

In an operation S402, the user terminal 120 may transmit the hailing service request to the hailing device 100. The hailing service request may include the hailing information input from the user 122. Additionally, the hailing service request may further include user data. As an example, the user data may include a current position of the user terminal 120. The user terminal 120 may collect the current position through a sensor such as a global positioning system (GPS). As another example, the user data may include personal information such as an age or height of the user 122. To this end, the user terminal 120 may receive the personal information from the user 122 and/or get consent for provision of the user data to the hailing device 100, before or after the user terminal 120 receives the hailing information.

In an operation S410, the hailing device 100 may identify one or more candidate vehicles for which the maintenance task will be requested to the user 122 based on the hailing service request. For example, the hailing device 100 may identify one or more pick-up candidate vehicles and/or one or more non-pick-up candidate vehicles according to the criterion described above in FIGS. 3A and 3B.

In an operation S420, the hailing device 100 may generate the maintenance request list for identified candidate vehicles and transmit the maintenance request list to the user terminal 120.

In an operation S422, the user terminal 120 may display the received maintenance request list on the screen. For example, as illustrated in FIG. 5B, the user terminal 120 may overlay and display a graphic object corresponding to a position of each candidate vehicle and a graphic object indicating the expected driving route on the map. When the user 122 touches a specific graphic object, the user terminal 120 may provide detailed information on the candidate vehicle and/or maintenance task corresponding to the graphic object. As another example, the user terminal 120 may list information on each candidate vehicle and the maintenance task required for the candidate vehicle in a text form, as illustrated in FIG. 5C. In this case, the user terminal 120 may display candidate vehicles with high priority at an upper end of the screen. For example, as illustrated in FIG. 5C, when the level of difficulty of the maintenance task required for each candidate vehicle is lower, the priority may be higher. However, the present disclosure is not limited thereto.

In an operation S424, the user terminal 120 may receive a selection for one or more vehicles to accept the maintenance request from the user 122.

In an operation S426, the user terminal 120 may generate the maintenance acceptance list for the selected vehicles and transmit the maintenance acceptance list to the hailing device 100. For example, the maintenance acceptance list may include identifiers of target vehicles selected by the user 122.

In an operation S430, the hailing device 100 may determine a vehicle 140-1 to pick up the user 122 (hereinafter referred to as a pick-up vehicle) based on the maintenance acceptance list. As an example, when the pick-up candidate vehicles are included in the maintenance request list, or all maintenance request for the pick-up candidate vehicles are not accepted, the hailing device 100 may determine a zero-th type of vehicle (that is, a normal vehicle) adjacent to the current position of the user 122 as the pick-up vehicle 140-1. As another example, when at least one maintenance request for the pick-up candidate vehicles is accepted, the hailing device 100 may determine any one of the pick-up candidate vehicles for which the request has been accepted, as the pick-up vehicle 140-1. In this case, the other target vehicles not determined as the pick-up vehicle 140-1 may be referred to as non-pick-up vehicles 140-2.

As another example, the user 122 may select vehicles to accept the maintenance request in the operation S424 and directly designate the pick-up vehicle 140-1 from among the selected vehicles.

In an operation S440, the hailing device 100 may transmit a dispatch command to the determined pick-up vehicle 140-1. The dispatch command may include the hailing service request. When there is a target vehicle through which the pick-up vehicle 140-1 must pass among the selected target vehicles, the dispatch command may further include information on the target vehicle (for example, an identifier, position, route to pass through the position). For example, the hailing device 100 may transmit a dispatch command to instruct the pick-up vehicle 140-1 to pick up the user 122 at the pick-up position and move to the drop-off position via positions of the one or more target vehicles.

In an operation S450, when the determined pick-up vehicle 140-1 is the first type of vehicle, the hailing device 100 may further transmit a maintenance schedule notification for informing the pick-up vehicle 140-1 that maintenance is scheduled. Further, when the non-pick-up vehicle 140-2 is present in the maintenance acceptance list, the hailing device 100 may transmit the maintenance schedule notification to the non-pick-up vehicle 140-2 in an operation S452.

In an operation S460, the hailing device 100 may update status information of the vehicle according to the progress status of the maintenance task. As an example, the hailing device 100 may transmit the maintenance schedule notification to each vehicle 140-1 or 140-2, and then, change a maintenance task progress status of the vehicle 140-1 or 140-2 to ‘reserved’, thereby preventing a situation in which another user is requested to perform the maintenance task in a duplicated manner. As another example, the hailing device 100 may also change the type of the vehicle 140-1 to 140-2 to the zero-th type in response to reception of the maintenance completion notification from the user terminal 120 or each vehicle 140-1 or 140-2.

In an operation S470, the hailing device 100 may calculate the reward credit to be granted to the user 122 based on whether or not the maintenance task is completed. In an operation S472, the hailing device 100 may transmit a message for informing the user of the decided reward credit to the user terminal 120.

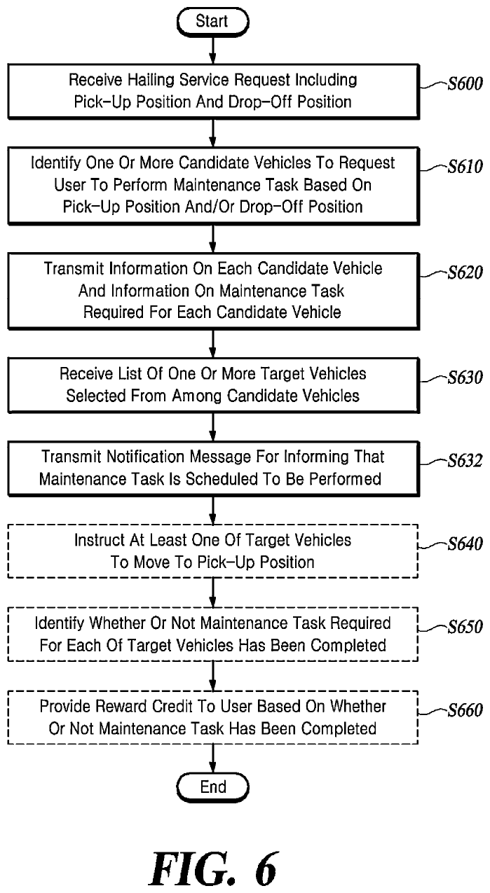

FIG. 6 is a flowchart illustrating an operation of the hailing device, according to an embodiment of the present disclosure.

In an operation S600, the hailing device 100 may receive the hailing service request including the pick-up position and the drop-off position from the user terminal 120. In some embodiments, the hailing service request may further include a desired departure time at the pick-up position of the called vehicle, the current position of the user 122, and/or personal information of the user 122. The personal information may include, for example, the height and/or age of the user 122.

In an operation S610, the hailing device 100 may identify one or more candidate vehicles to request the user 122 to perform a maintenance task based on the pick-up position, the drop-off position, or a combination thereof.

In an embodiment, each candidate vehicle may correspond to either a pick-up candidate vehicle for which the user 122 is requested to perform the maintenance task at the pick-up position, or a non-pick-up candidate vehicle for which the user 122 is requested to move to a current position of the candidate vehicle and perform the maintenance task. The pick-up candidate vehicle may be identified from among vehicles having a first type of status that is predefined as that capable of traveling even when the required maintenance task is not completed, and the non-pick-up candidate vehicle may be identified from among vehicles having a second type of status that is predefined as that incapable of traveling until the required maintenance task is completed. The vehicle having the first type of status may be, for example, a vehicle for which one or more of the user 122 visually checking whether or not there is an abnormality, refilling a sensor cleaning fluid, closing a hood or door, and replacing or cleaning a component predefined as non-essential for autonomous driving are required as maintenance tasks. The vehicle having the second type of status may be, for example, a vehicle for which one or more of removing obstacles around the vehicle and replacing or cleaning a component predefined as essential for autonomous driving as maintenance tasks.

In the operation S610, the hailing device 100 may identify pick-up candidate vehicles and/or non-pick-up candidate vehicles based on whether the first type of vehicle and/or the second type of vehicle satisfies preset conditions.

As an example, the hailing device 100 may identify, among vehicles having a first type of status (hereinafter referred to as first vehicles), a first vehicle satisfying a preset first condition associated with the pick-up position as the pick-up candidate vehicle. Here, the first condition may be satisfied when the first vehicle can arrive at the pick-up position before a predetermined time. Additionally, or alternatively, the first condition may be satisfied when the user 122 is expected to be able to complete the maintenance task required for the first vehicle before the desired departure time.

As another example, the hailing device 100 may identify, among the vehicles having the second type of status (hereinafter referred to as second vehicles), a second vehicle satisfying a preset second condition associated with the current position of user 122 as the non-pick-up candidate vehicle. The second condition may be satisfied when the second vehicle is located on a walking route between the current position of user and the pick-up position. Additionally, or alternatively, the second condition may be satisfied when a length of the walking route via the second vehicle is equal to or smaller than a predetermined threshold length. Additionally, or alternatively, the second condition may be satisfied when the user 122 is expected to be able to complete the maintenance task required for the second vehicle and arrive at the pick-up position, before the desired departure time. In some embodiments, the hailing device 100 may not identify the second vehicle satisfying the second condition when a distance between the current position and the pick-up position is smaller than a predetermined threshold distance.

As another example, the hailing device 100 may identify, among the vehicles having the first or second type of status (hereinafter referred to as third vehicles), a third vehicle satisfying a preset third condition associated with the pick-up position and the drop-off position as the non-pick-up candidate vehicle. The third condition may be satisfied when the third vehicle is located on a driving route between the pick-up position and the drop-off position. Additionally, or alternatively, the third condition may be satisfied when the length of the driving route via the third vehicle is equal to or smaller than a predetermined threshold length.

In an operation S620, the hailing device 100 may provide, to the user terminal 120, information on each candidate vehicle and the information on the maintenance task required for each candidate vehicle. Here, the information on the maintenance task includes at least one of the content of the maintenance task, the expected time required for the maintenance task, the level of difficulty of the maintenance task, and the reward credit expected to be able to be obtained by the user 122 upon completion of the maintenance task. The information on candidate vehicles may include, for example, the position of each candidate vehicle. As another example, the information on the candidate vehicles may include a time expected to be additionally required by the user 122, another candidate vehicle distinguishing from the candidate vehicle, or a vehicle (e.g. normal vehicle) for which the maintenance task is not required passing through a position of the candidate vehicle.

In an operation S630, the hailing device 100 may receive a selection of one or more candidate vehicles from the user terminal 120. The hailing device 100 may provide the user 122 with a detailed guidance of the maintenance task required for each of the selected candidate vehicles (hereinafter referred to as target vehicles). As an example, the hailing device 100 may transmit a video showing a maintenance task process to the user terminal 120. As another example, the hailing device 100 may assign a counselor to provide a guidance to the user 122, based on the level of difficulty of the maintenance task required for each of the target vehicles and an expected start time of the maintenance task.

In an operation S632, the hailing device 100 may transmit a notification message for informing the target vehicles that the maintenance task is scheduled to be performed.

Optionally, in an operation S640, the hailing device 100 may instruct at least one of the target vehicles to move to the pick-up position. For example, when the target vehicles include both one or more first vehicles and one or more second vehicles, the hailing device 100 may instruct one of the first vehicles to pick up the user 122 at the pick-up position and move to the drop-off position via a position of the second vehicle.

Optionally, in an operation S650, the hailing device 100 may identify whether or not the maintenance task required for each of the target vehicles has been completed. As an example, the hailing device 100 may receive whether or not the maintenance task has been completed from at least one of the target vehicles. As another example, the hailing device 100 may receive an image obtained by capturing at least one of the target vehicles. The image may be a still image or a video captured through the target vehicle itself or the user terminal 120. The hailing device 100 may identify whether the maintenance task required for the vehicle have been completed based on the received image.

Optionally, in an operation S660, the hailing device 100 may provide reward credit to the user 122 based on whether or not the maintenance task has been completed. The reward credit may be determined based on one or more of a traveling time additionally taken by passing through the target vehicles, the time taken for the maintenance task, and the level of difficulty of the maintenance task.

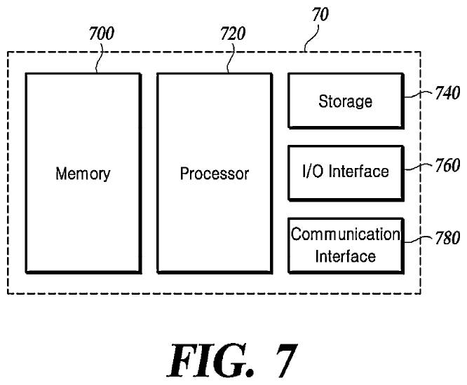

FIG. 7 is a block diagram schematically illustrating an example computing device that can be used to implement the methods or devices according to embodiments of the present disclosure.

A computing device 70 may include some or all of a memory 700, a processor 720, a storage 740, an input and output (I/O) interface 760, and a communication interface 780. The computing device 70 may structurally and/or functionally include at least a portion of the hailing device 100 or the user terminal 120. The computing device 70 may be a stationary computing device such as a desktop computer, a server, or an AI accelerator, or a mobile computing device such as a laptop computer or a smart phone.

The memory 700 may store a program that allows the processor 720 to perform methods or operations according to various embodiments of the present disclosure. For example, the program may include a plurality of instructions that are executable by the processor 720. The method illustrated in FIG. 6 may thus be performed by the plurality of instructions being executed by the processor 720.

The memory 700 may be a single memory or a plurality of memories. In this case, information required to perform methods or operations according to various embodiments of the present disclosure may be stored in the single memory or divided and stored in the plurality of memories. When the memory 700 is configured of the plurality of memories, the plurality of memories may be physically separated.

The memory 700 may include at least one of a volatile memory and a non-volatile memory. The volatile memory includes a static random access memory (SRAM), a dynamic random access memory (DRAM), or the like, and the non-volatile memory includes a flash memory.

The processor 720 may include at least one core capable of executing at least one instruction. The processor 720 may execute instructions stored in the memory 700. The processor 720 may be a single processor or a plurality of processors.

The storage 740 maintains stored data even when power supplied to the computing device 70 is cut off. For example, the storage 740 may include a non-volatile memory or may include a storage medium such as a magnetic tape, optical disc, or magnetic disk.

A program stored in the storage 740 may be loaded into the memory 700 before being executed by the processor 720. The storage 740 may store files created in a program language, and a program created from a file by a compiler or the like may be loaded into the memory 700. The storage 740 may store data to be processed by the processor 720 and/or data processed by the processor 720.

The I/O interface 760 may include an input device such as a keyboard or mouse, and may include an output device such as a display device or printer. An administrator or the user 122 of the hailing service can trigger execution of a program in the processor 720 and/or check a processing result of the processor 720 through the I/O interface 760.

The communication interface 780 may provide access to an external network. For example, the computing device 70 may communicate with another device (for example, the user terminal 120 or the vehicle 140) via the communication interface 780.

Each component of the apparatus or method according to the present disclosure may be implemented as hardware or software, or a combination of hardware and software. Furthermore, the function of each component may be implemented as software and a microprocessor may be implemented to execute the function of software corresponding to each component.

Various implementations of systems and techniques described herein may be realized as digital electronic circuits, integrated circuits, field programmable gate arrays (FPGAs), application-specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications, or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as a read-only memory (ROM), compact disk ROM (CD-ROM), magnetic tape, floppy disk, memory card, hard disk, magneto-optical disk, or storage device, and may further include a transitory medium such as a data transmission medium. In addition, the computer-readable recording medium may be distributed in a computer system connected via a network, so that computer-readable codes may be stored and executed in a distributed manner.

The flowchart/timing diagrams of the present specification illustrate processes as sequentially executed. However, this is merely illustrative of the technical idea of embodiments of the present disclosure. It should be apparent to those having ordinary skill in the art that an order described in the flowchart/timing diagrams may be changed or one or more processes may be executed in parallel without departing from the essential characteristics of embodiments of the present disclosure. Thus, the flowchart/timing diagrams are not limited to a time-series order.

According to an embodiment of the present disclosure, it is possible to induce a user to perform a maintenance task on a pick-up vehicle, and/or another vehicle located on a walking or driving route, through communication with a user of the hailing service. The user can receive financial benefits depending on a level of difficulty of the maintenance task and a time delay caused by the maintenance task. Further, a hailing service provider can save labor and time required for the maintenance task.

According to an embodiment of the present disclosure, it is possible to request a user to perform the maintenance task for a candidate vehicle while not interfering with the user using the hailing service, by identifying the candidate vehicle based on a hailing service request of the user.

According to an embodiment of the present disclosure, it is possible to assist in a selection of a user by providing the user with description of the maintenance task required for the candidate vehicle and an expected time required for the maintenance task.

According to an embodiment of the present disclosure, it is possible to efficiently perform a maintenance task of an autonomous vehicle with no driver.

The effects of the present disclosure are not limited to the effects mentioned above. Other effects not mentioned may be clearly understood by those having ordinary skill in the art from the description above.

Although certain embodiments of the present disclosure have been described for illustrative purposes, those having ordinary skill in the art should appreciate that various modifications, additions, and substitutions are possible, without departing from the idea and scope of the claimed disclosure. Therefore, embodiments of the present disclosure have been described for the sake of brevity and clarity. The scope of the technical idea of the present disclosure is not limited by these illustrative embodiments. Accordingly, the scope of the claimed disclosure is not limited by the above explicitly described embodiments. The scope of the present disclosure is defined by the appended claims and equivalents thereof.

What is claimed is:

1. A computer-implemented method for vehicle maintenance, comprising:
receiving, from a user terminal, a hailing service request including a pick-up position and a drop-off position;
identifying one or more candidate vehicles to request a user of the user terminal to perform a maintenance task based on one or both of the pick-up position or the drop-off position;
transmitting, to the user terminal, information on each candidate vehicle and information on the maintenance task required for each candidate vehicle;
receiving, from the user terminal, a list of one or more target vehicles selected from among the candidate vehicles; and
transmitting, to the one or more target vehicles, a notification message for informing that the maintenance task is scheduled to be performed.

2. The computer-implemented method of claim 1, wherein each candidate vehicle, among the one or more candidate vehicles, corresponds to either a first candidate vehicle for which the user is requested to perform the maintenance task at the pick-up position or a second candidate vehicle for which the user is requested to move to a current position of the candidate vehicle and perform the maintenance task.

3. The computer-implemented method of claim 2, wherein:
the first candidate vehicle is identified from among one or more vehicles having a first type of status predefined as vehicles capable of traveling even when a required maintenance task is not completed; and
the second candidate vehicle is identified from among one or more vehicles having the first type of status and one or more vehicles having a second type of status predefined as vehicles incapable of traveling until a required maintenance task is completed.

4. The computer-implemented method of claim 3, wherein identifying the one or more candidate vehicle includes identifying, from among vehicles having the first type of status, one or more first candidate vehicles based on whether a first condition associated with the pick-up position is satisfied, wherein the first condition includes a first sub condition in which the first candidate vehicle is able to arrive at the pick-up position before a predetermined time.

5. The computer-implemented method of claim 4, wherein:
the hailing service request further includes a desired departure time at the pick-up position; and
the first condition further includes a second sub condition in which the user is able to complete a maintenance task required for the first candidate vehicle before the desired departure time.

6. The computer-implemented method of claim 3, wherein:
the hailing service request further includes a current position of the user; and
identifying the one or more candidate vehicles includes identifying, from among vehicles having the second type of status, one or more second candidate vehicles based on whether a second condition associated with the current position is satisfied, wherein the second condition includes a first sub condition in which i) the second candidate vehicle is located on a walking route between the current position and the pick-up position and ii) a length of the walking route is equal to or smaller than a predetermined threshold length.

7. The computer-implemented method of claim 6, wherein:
the hailing service request further includes a desired departure time at the pick-up position; and
the second condition further includes a second sub condition in which, before the desired departure time, the user is able to complete a maintenance task required for the second candidate vehicle and arrive at the pick-up position.

8. The computer-implemented method of claim 6, wherein identifying the one or more candidate vehicles includes determining whether each of the vehicles having the second type of status satisfy the second condition when a distance between the current position and the pick-up position is equal to or greater than a predetermined threshold distance.

9. The computer-implemented method of claim 3, wherein identifying the one or more candidate vehicles includes identifying, from among one or more vehicles having the first type of status or the second type of status, one or more second candidate vehicles based on a third condition associated with the pick-up position and the drop-off position is satisfied, wherein the third condition includes a sub condition in which i) the second candidate vehicle is located on a driving route between the pick-up position and the drop-off position and ii) a length of the driving route is equal to or smaller than a predetermined threshold length.

10. The computer-implemented method of claim 3, wherein the maintenance task required for vehicles having the first type of status includes one or more of the user visually checking whether or not there is an abnormality, refilling a sensor cleaning fluid, closing a hood or door, or replacing or cleaning a component predefined as non-essential for autonomous driving.

11. The computer-implemented method of claim 3, wherein the maintenance task required for the vehicles having the second type of status includes one or more of removing obstacles present in surroundings, or replacing or cleaning a component predefined as essential for autonomous driving.

12. The computer-implemented method of claim 2, further comprising transmitting, in response to the first candidate vehicle selected as a target vehicle, an instruction message instructing the first candidate vehicle to pick up the user at the pick-up position and move to the drop-off position.

13. The computer-implemented method of claim 2, wherein transmitting the information on the second candidate vehicle includes transmitting a time expected to be additionally required by the user, the first candidate vehicle, or another vehicle for which the maintenance task is not required passing through a position of the second candidate vehicle.

14. The computer-implemented method of claim 1, wherein the information on the maintenance task includes one or more of content of the maintenance task, an expected time required for the maintenance task, a level of difficulty of the maintenance task, or reward credit expected to be able to be obtained by the user upon completion of the maintenance task.

15. The computer-implemented method of claim 1, wherein:
the hailing service request further includes personal information of the user; and
the one or more candidate vehicles are identified based on whether a maintenance task required for the candidate vehicles satisfy a condition associated with the personal information.

16. The computer-implemented method of claim 1, further comprising receiving, from at least one of the target vehicles, a message indicating whether or not the maintenance task is completed.

17. The computer-implemented method of claim 1, further comprising:
receiving one or more images of at least one of the target vehicles; and
identifying whether or not a maintenance task required for at least one of the target vehicles has been completed based on the one or more images.

18. The computer-implemented method of claim 1, further comprising providing reward credit to the user based on whether the maintenance task required for each of the target vehicles has been completed, wherein the reward credit is determined based on one or more of a traveling time additionally taken by passing through the target vehicles, or a time taken for the maintenance task, a level of difficulty of the maintenance task.

19. A device, comprising:
a memory configured to store instructions; and
at least one processor configured to execute the instructions to
receive, from a user terminal, a hailing service request including a pick-up position and a drop-off position,
identify one or more candidate vehicles to request a user of the user terminal to perform a maintenance task based on the pick-up position, the drop-off position, or a combination thereof,
transmit, to the user terminal, information on each candidate vehicle and information on the maintenance task required for each candidate vehicle,
receive, from the user terminal, a list of one or more target vehicles selected from among the candidate vehicles, and
transmit, to the target vehicles, a notification message for informing that the maintenance task is scheduled to be performed.
